(19) United States
(12) Patent Application Publication
(10) Pub. No.: US 2009/0245831 A1
(43) Pub. Date: Oct. 1, 2009

(54) IMAGE FORMING APPARATUS

(75) Inventors: Eiji Nishikawa, Hino-shi (JP); Satoshi Ogata, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/407,411

(22) Filed: Mar. 19, 2009

(30) Foreign Application Priority Data
Mar. 26, 2008 (JP) 2008-080050

(51) Int. Cl. G03G 15/043; G03G 15/08

(52) U.S. Cl. 399/51; 399/221; 399/53

(57) ABSTRACT

An image forming apparatus including: an image carrier; an exposure section that deflects an optical beam using a rotating polygon mirror to expose a surface of the image carrier; a developing section that supplies a toner in order to visualize an electrostatic latent image formed by the exposure section on the image carrier with a toner; and a control section that controls at least the exposure section and the developing section, wherein the control section controls the exposure section and the developing section so as to form a solid image for correction on a non image area which passes through an exposure position in a period within which a plane phase of the rotating polygon mirror is corrected among non image areas between imaging areas on the image carrier.

This application is based on Japanese Patent Application No. 2008-80050 filed on Mar. 26, 2008, the entire content of which is hereby incorporated by reference.

### BACKGROUND

1. Field of the Invention

The present invention relates to an image forming apparatus which forms an image on sheets of a copying machine, a printer and a facsimile machine (FAX). [Related Art]

2. Description of Related Art

In an image forming apparatus, such as copying machines, printers and facsimile machines, many of them have adopted an electro photography system which forms an image on a sheet with toner. There are also many color image forming apparatuses which form a color picture with the toner of a plurality of colors. In recent years, there has been appeared color image forming apparatuses of a tandem type color image forming apparatus, which lays the toner image of each color on top of an intermediate transfer member by providing a photoconductor, an exposure section and a developing section for each color in consideration of a high throughput.

By the way, it is requested by users that a high quality image having no temporal change is outputted on a sheet. In the image forming apparatus mentioned above, a correction operation for stabilizing image quality is periodically executed. The correction operation periodically executed is to perform a position shift correction operation which corrects the exposure position in an exposure section and an operation which corrects the density of the image so as to overlap toner images of each color of yellow (Y), magenta (M), cyanogens (C) and black (K) without shifting onto an intermediate transfer member, for example.

In order to execute position shifting correction operation and the image density correction operation, it is necessary to form an image pattern for correction onto a photoconductor or an intermediate transfer member, and to read the image pattern by a sensor. However, in order to form an image pattern, it is not preferred to stop a print job currently executed with image forming apparatus in a viewpoint of productivity. Therefore, various technologies of not stopping a print job but executing correction operation are proposed.

The technology disclosed in Japanese Unexamined Patent Application Publication No. 10-213940 is the technology of forming an image pattern for the position shifting correction on a position between paper sheets onto which an image on a transfer belt is formed (non image area), detecting the image pattern by a sensor and controlling a plane phase of a polygon in an exposure section. According to the technology, since the print job executed with image forming apparatus is not stopped, the correction operation of position shifting can be executed while preventing deterioration of productivity.

In a case where forming an image pattern for position shifting correction (for exposure position correction) in a non image area and controlling the plane phase of the polygon like the technology disclosed in Japanese Unexamined Patent Application Publication No. 10-213940, the rotation operation of the polygon is unstable under the correction of the phase position of the polygon or after or after the correction for a while. Therefore, the image pattern for correction in which strict shape is required cannot be formed on the photoconductor while the rotation operation of the polygon is unstable. Therefore, the formation of the image pattern for correction will not be executed in principle until the rotation operation of the polygon becomes stabilized, although it is the timing in which other correction operations should be executed.

However, the solid image for correction formed on the photoconductor in order to correct the highest density of the image, and the solid image formed on the photoconductor in order to compulsorily eject toner from the developing section are not influenced even though the rotation operation of the polygon is unstable. Therefore, in case when the correction operation of the highest density of the image, which is under the timing where the correction operation should be executed, is not executed until the rotation operation of the polygon is stabilized, there is a possibility that the correction operation against the image may be overdue and image quality may deteriorate.

### SUMMARY

An object of the present invention is to provide an image forming apparatus which prevents deterioration of productivity while executing a correction operation which stabilizes image quality without delay.

An image forming apparatus reflecting one aspect of the present invention comprises: an image carrier; an exposure section that deflects an optical beam using a rotating polygon mirror to expose a surface of the image carrier; a developing section that supplies a toner in order to visualize an electrostatic latent image formed by the exposure section on the image carrier with a toner; and a control section that controls at least the exposure section and the developing section, wherein the control section controls the exposure section and the developing section so as to form a solid image for correction on a non image area which passes through an exposure position in a period within which a plane phase of the rotating polygon mirror is corrected among non image areas between imaging areas on the image carrier.

### BRIEF DESCRIPTION OF THE DRAWINGS

FIG. 1 illustrates a central sectional view showing the internal configuration of an image forming apparatus.

FIG. 2 illustrates a perspective view showing the internal structure of an exposure section.

FIG. 3 illustrates a block diagram of a control system of the image forming apparatus.

FIG. 4 illustrates an explanatory view for explaining an image pattern for position shifting correction, which has been formed in the non image area of an intermediate transfer belt.

FIG. 5 illustrates an enlarged view of the image pattern for position shifting correction.

FIG. 6 illustrates an explanatory view for explaining the correction of the phase of a drive clock and the phase of an index signal in a polygon.

FIG. 7 illustrates an explanatory view in which the image pattern for the highest density correction has been formed to the non image area of the intermediate transfer belt.

FIG. 8 illustrates an explanatory view in which the image pattern for compulsive ejection has been formed in the non image area of the intermediate transfer belt.

FIG. 9 illustrates a flow chart showing the operation for executing the correction operation of the highest density while correcting the plane phase of a polygon.

FIG. 10 illustrates the explanatory view in which the image pattern for the highest density correction has been formed in the downstream side of the non image area in which the image pattern for position shifting correction has been formed.

FIG. 11 illustrates the explanatory view in which the image pattern for compulsive ejection has been formed in the downstream side of the non image area in which the image pattern for position shifting correction has been formed.

FIG. 12 illustrates the explanatory view in which the image pattern for the highest density correction, and the image pattern for compulsive ejection have been formed in the downstream side of the non image area in which the image pattern for position shifting correction has been formed.

### DESCRIPTION OF THE PREFERRED EMBODIMENTS

### [The Outline of Image Forming Apparatus]

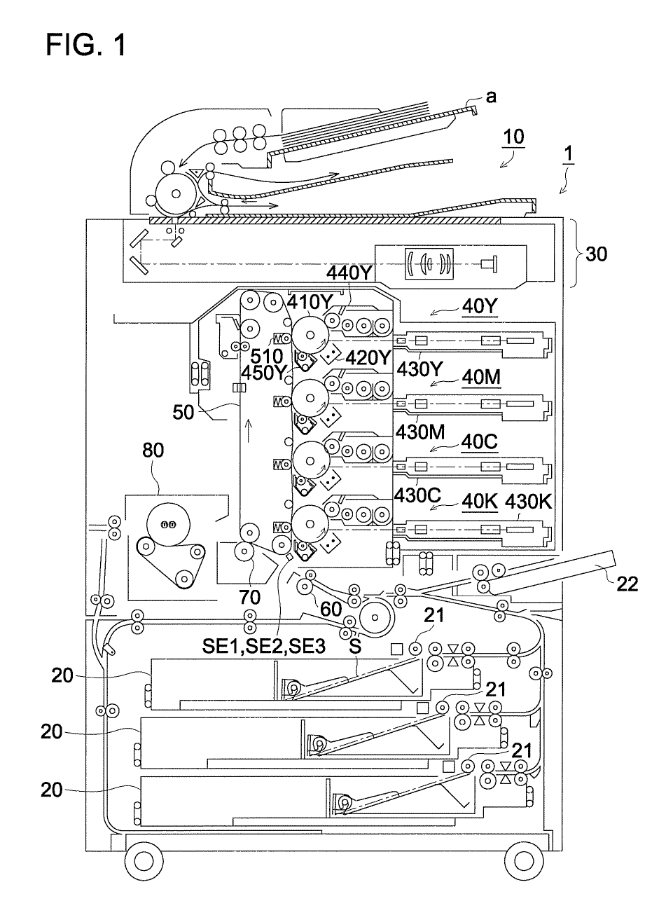

FIG. 1 is a central sectional view showing the internal configuration of an image forming apparatus 1 related to the present invention. The image forming apparatus 1 is a tandem type color image forming apparatus which has an intermediate transfer belt 50. The document set to a document feeding stand “a” of a double-sided automatic document feeding apparatus 10 is conveyed towards an image reading section 30 with various rollers.

A plurality of sheet storage sections 20 is installed in the lower part of the image forming apparatus 1. The intermediate transfer belt 50 is installed above the sheet storage sections 20, and the image reading section 30 is installed in the upper portion of the main body of the apparatus.

A drawer to the front side of the apparatus (the front side of this paper sheet of FIG. 1) is possible for the sheet storage section 20. Sheets S, such as a blank paper sheets, are divided and accommodated in the plurality of sheet storage sections 20 based on the size. Sheet S accommodated in the sheet storage section 20 is fed with a feed roller 21 sheet by sheet. Special papers, such as a usual paper sheet and an OHP sheet are set to a manual document feeder section 22.

4 sets of image formation engines 40Y, 40M, 40C and 40K for forming a toner image of each color of Y, M, C and K are installed above the sheet storage section 20. Image formation engines 40Y, 40M, 40C and 40K are arranged in the shape of a straight line downward from the top in this order, and have the same structure respectively. With respect to the order of the arrangement of these image formation engines 40Y, 40M, 40C, and 40K, in particular, it is not limited to this order. The image formation engine 40Y for yellow will be explained as an example. The image formation engine 40Y includes a photoconductor (an image carrier) 410Y which rotates counterclockwise, a scorotron charging section 420Y, an exposure section 430Y, a developing section 440Y and a cleaning section 450Y. The cleaning section 450Y is arranged so as to include the area opposed to the lowermost part of the photoconductor 410Y. Since, as shown in FIG. 1, the image forming apparatus 1 includes a plurality of photoconductors and an exposure section, and the toner of each color overlaps onto the intermediate transfer belt 50 one by one, high-speed image formation is possible.

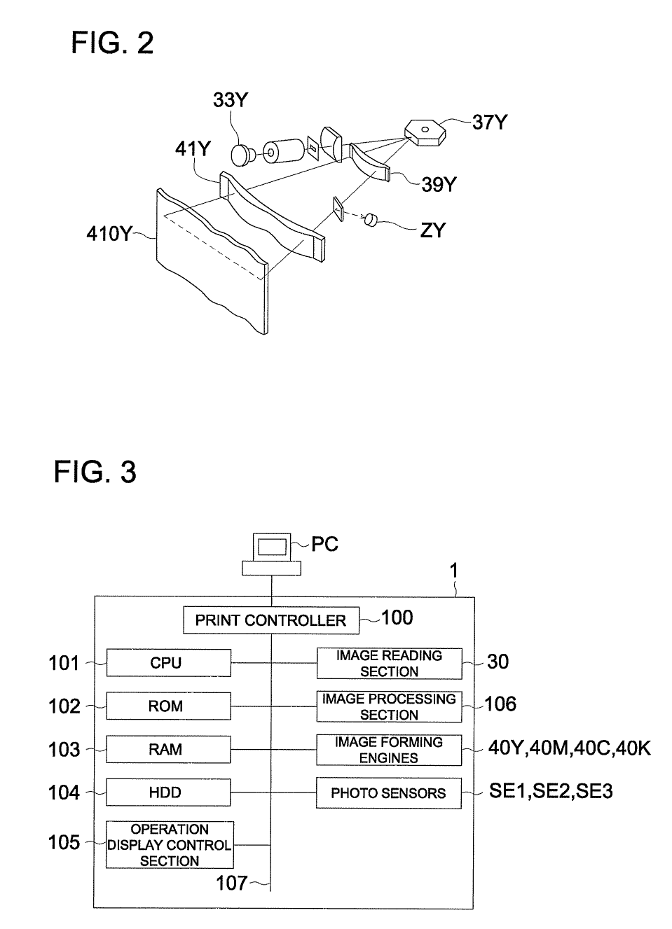

FIG. 2 illustrates a perspective view showing the internal structure of the exposure section 430Y.

Exposure sections 430Y, 430M, 430C and 430K are installed in the image forming apparatus 1 for each color, and each exposure section has the same internal structure as illustrated in FIG. 2. Here, on behalf of the exposure sections, the exposure section 430Y for yellow will be explained.

33Y is a laser light source which emits laser beams (optical beams) modulated based on a picture signal for yellow. The laser beams are reflected by the mirror surface in a polygon (rotation multiple mirror) 37Y, and the laser beams emitted from the laser light source 33Y expose the surface of the photoconductor 410Y through an fθ lens 39Y and a cylindrical lens 41Y. An electrostatic latent image is formed on the surface of the photoconductor 410Y by the exposure of this laser beam. ZY is an index sensor. The index sensor ZY detects the scan start of the laser beams in the main scanning direction, and outputs the index signal which is a Horizontal Synchronizing signal.

Returning to FIG. 1 and the explanation of the image forming apparatus 1 will be continued. A primary transfer electrode 510 is installed at the position which opposes to the photoconductor 410Y so as to sandwich an endless intermediate transfer belt 50 located in the central part of the main body of the apparatus.

A photo sensor SE1 detects the image pattern for correction formed on the intermediate transfer belt 50, and the density correction of the image and the position shifting correction are executed based on the detected result.

Next, how to form a color image in the image forming apparatus 1 will be described.

The photoconductor 410Y is rotated by a drum drive motor (not shown), and is charged in negative polarity by the electric discharge of the scorotron charging section 420Y (for example, −800V). Next, the optical writing onto the photoconductor 410Y corresponding to the image information is conducted by the exposure section 430Y, and an electrostatic latent image is formed. When the formed electrostatic latent image passes through the developing section 440Y, the toner charged in negative polarity within a developing section is supplied to the portion of the latent image by applying negative polarity development bias from the developing section, and the toner adheres. Then, the toner image is formed on the photoconductor 410Y. The formed toner image is transferred onto the intermediate transfer belt 50 stuck to the photoconductor 410Y by pressure. The toner which remained on the photoconductor 410Y after transfer is cleaned by the cleaning section 450Y.

A color image is formed on the intermediate transfer belt 50 by overlapping the toner images respectively formed in the image formation engines 40Y, 40M, 40C and 40K and transferring them onto the intermediate transfer belt 50.

The sheet S is fed one by one at a time from the sheet storage section 20, and conveyed to the position of a registration roller 60 which functions as a registration conveyance section. The sheet S is butted to the registration roller 60, and is temporally stopped. Then the straightness of the sheet S is corrected. The sheet S is fed by the registration roller 60 at the timing when the toner image on the intermediate transfer belt 50 coincides with the image position.

The sheet S which has been fed by the registration roller 60 is guided by a guide plate, and is sent into the transfer NIP position structured by the intermediate transfer belt 50 and a transfer section 70. The transfer section 70 configured with rollers is pressing the sheet S to the intermediate transfer belt 50 side. By applying the bias (for example, +500V) having a reverse polarity against the toner to the transfer section 70, the toner image on the intermediate transfer belt 50 is transferred onto the sheet S by the operation of an electro static force. Electricity is discharged by a separation apparatus (not shown) which is structured by an electric discharge needle thereby the sheet S is separated from the intermediate transfer belt 50. Then, the sheet S is conveyed to a fixing apparatus 80 formed by a heating roller, a pressing roller and a fixing belt. As a result, a toner image is fixed onto the sheet S, and the sheet S onto which an image has been formed is ejected out of the apparatus.

Image forming apparatus 1 in this embodiment forms a color image on a sheet with a tandem type. However the image forming apparatus related to the present invention in not limited to this embodiment.

### [Block Diagram of Control System in Image Forming Apparatus]

FIG. 3 illustrates a block diagram of a control system of the image forming apparatus 1, and shows only a typical control system here. CPU (Central Processing Unit) 101 is connected to ROM(Read Only Memory) 102 and RAM(Random Access Memory) 103 via system bus 107. This CPU101 reads various programs stored in the ROM102 and expands them onto the RAM103. The CPU 101 controls the operation of each section which contains at least an exposure section and a developing section. The CPU101 executes various processes according to the programs expanded onto the RAM103, and while the CPU 101 stores the processing results in the RAM103, it allows an operation display control section 105 to display it.

And the CPU 101 allows a predetermined storage place to save the processing result stored in the RAM103. In this embodiment, the CPU101 configures a control section by collaborating with the ROM102 and the RAM103.

The printer controller 100 is connected with the PC which is a terminal via the network. The printer controller 101 receives the print job transmitted from the PC. The controller 101 watches the operation of the image forming apparatus 1 and transmits the information with respect to the image forming apparatus 1, which includes, for example, the remaining amount information of consumption articles to the PC when there is a request from the PC.

The ROM102 has memorized a program and data in advance and typically comprises a semiconductor memory.

The RAM103 forms the work area which temporarily memorizes the data which were processed by the various programs executed by the CPU101.

HDD104 has the functions for memorizing the image data of the document image read and obtained by the image reading section 30, and for memorizing outputted image data. HDD104 comprises what is called a hard disk drive.

The operation display control section 105 enables various kinds of setups. The operation display control section 105 acts as, for example, a touch-panel system. And when a user performs input operations through the operation display control section 105, the conditions with respect to color printing or monochrome printing can be set up. Various kinds of information, including the information on a network setup will be displayed on the operation display control section 105.

The image reading section 30 optically reads a document image and converts it into an electric signal. In case where the image reading section 30 reads a color copy, image data having luminosity information of 10 bits per pixel for each RGB is generated.

The image data generated by the image reading section 30 and the image data transmitted from the PC connected to the image forming apparatus 1 will be processed by the image processing section 106. In case when executing color printing with the image forming apparatus 1, the image data of R (Red), G (Green) and B (Blue) generated by the image reading section 30 are inputted into a color conversion LUT in the image processing section 106. The image processing section 106 converts R-G-B data to the image data of yellow, magenta, cyan and black. And the image processing section 106 conducts the correction of the gradation reappearance characteristic, performs a screen treatment, such as a halftone dot, with reference to the density correction LUT, and performs edge processing for emphasizing a fine line against the image data to which color conversion has been performed.

The Image formation engines 40Y, 40M, 40C and 40K receive the image data which has been processed by the image processing section 106, and form an image on a sheet. Photo sensor SE1, SE2 and SE3 detect the image pattern for correction. Based on the detected result, the CPU 101 controls the operations of image formation engines 40Y, 40M, 40C and 40K.

The Image forming apparatus 1 periodically executes the correction operation in order to stabilize the image quality. The correction operation executed by the image forming apparatus 1 includes a correction operation of an image position shifting and the correction operation of the highest density, for example.

Although it is not the operation for detecting and correcting an image pattern, there is also the operation for compulsorily ejecting toner from the developing section 440Y and the like as the operation which corrects the image formation conditions.

Hereafter, these correction operations are explained.

### [Correction Operation of Position Shifting]

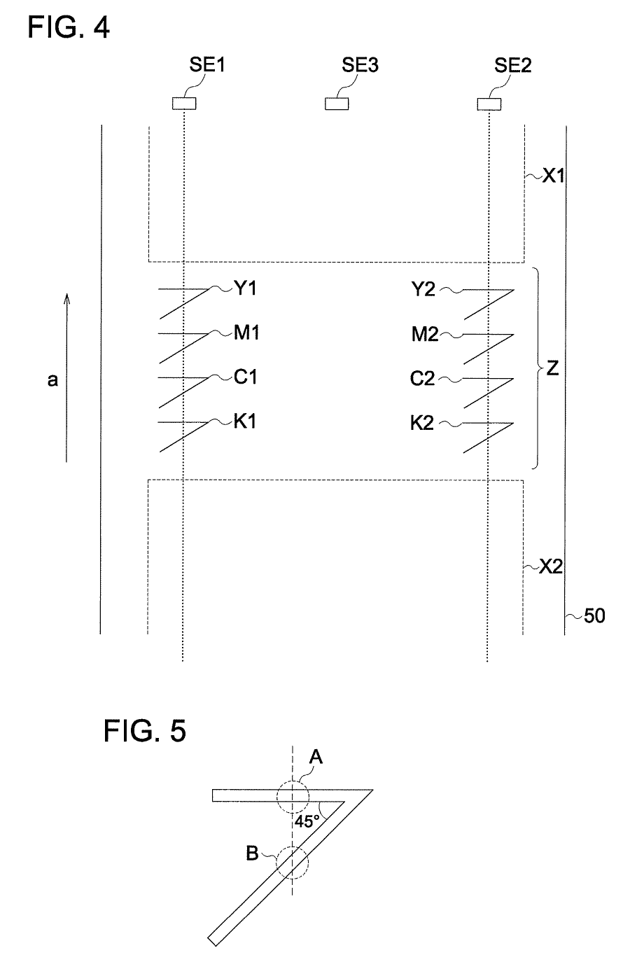

Firstly, the correction operation of position shifting will be described using FIGS. 4-6. In order to form a high-definition color image on the sheet S, it is necessary to overlap the toner image of each color onto the intermediate transfer belt 50 without shifting. Then, the exposure positions to the photoconductor by each of the exposure sections 430Y, 430M, 430C and 430K are periodically corrected in order to correct the position shifting of the toner image of each color temporally created. That is, the correction operation of position shifting is an operation correcting the exposure position by the exposure section.

In order to execute the correction operation of position shifting, as illustrated in FIG. 4, image patterns Y1, Y2, M1, M2, C1, C2, K1, and K2 for position shifting correction (for exposure position correction) which are characters of “7”, are formed on intermediate transfer belt 50. An image pattern for position shifting correction is formed in the non image area Z between imaging areas X1 and X2 on the intermediate transfer belt 50 (the non image area of the intermediate transfer belt 50 is equivalent to a non image area of each photoconductor). Since it is not necessary to stop a print job which is performed by the image forming apparatus 1 by forming an image pattern on the non image area Z, the lowering of productivity can be prevented. The term “imaging area” means an area on an image carrier such as the photoconductor or the intermediate transfer belt, that corresponds to a sheet of paper to which an image formed on the area is to be transferred. And the term “non image area” means an area on the image carrier between an imaging area and subsequent imaging area.

As illustrated in FIG. 4, an image pattern of a character of “7” is formed in the left-hand side and the right-hand side of the intermediate transfer belt 50 for each color, and image patterns of a total of eight positioned in right and left are formed in one non image area. Image patterns which adjoin each other in right and left are the same color, and are formed in order of Y, M, C and K.

The left-hand side image pattern is detected by a photo sensor SE1, and the right-hand side image pattern is detected by a photo sensor SE2. As illustrated in FIG. 5, an angle of an image pattern of the character of “7” is 45 degrees, and A area and B area of each image pattern are detected by movement (the direction of “a” in FIG. 4) of the intermediate transfer belt 50. Based on a difference of detected times of A area and B area with respect to each image pattern, each color position shifting (an exposure position shift) is calculated, and exposure positions to the photoconductor by each exposure section of 430Y, 430M, 430C and 430K are corrected by the CPU101.

The correction of an exposure position is performed by with a unit of an index signal “β”, in other words, by correcting the phase between each index signal besides a unit of one scanning line and slightly shifting the exposure position to enables the correction which is equal to or less than one scanning line. When concretely describing, the position shifting of one scan line unit will be corrected by correcting an imaging area signal. Position shifting less than one line is corrected by correcting a phase of a drive clock “α” in a polygon in the exposure section, i.e., the plane phase of the polygon, (the plane phase of the polygon is corrected in order to correct the exposure position).

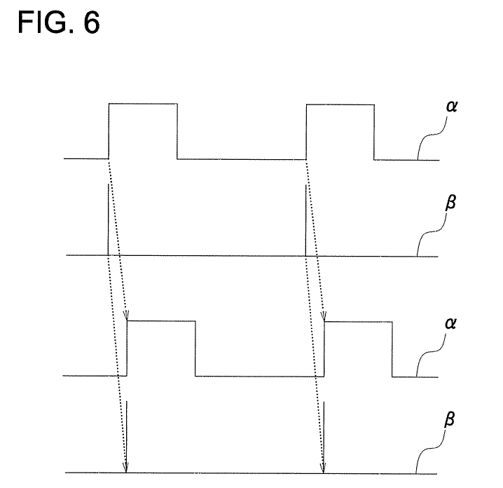

As illustrated in FIG. 6, based on the calculated position shifting information, a polygon motor is controlled by the phase control of a drive clock “α” in the polygon, a phase of index signal “β” is corrected (as illustrated in an arrow of a dotted line) and the position shifting less than one line is corrected. The term “a period within which a plane phase of the rotating polygon mirror is corrected” means a period of time from a start of a plane phase correction to a time when the rotating polygon mirror becomes stable. “The stable state of the rotating polygon mirror” means that an oscillating quantity becomes a predetermined value or less. The period of time from a start of a plane phase correction to a time when the rotating polygon mirror becomes stable is set a proper value obtained from experiments or experiences. As the time necessary for the rotating polygon mirror to become stable is determined by the adjusting amount of the plane phase, it is also possible to set the proper value according to the adjusting amount of the plane phase.

### [Correction Operation of Highest Density]

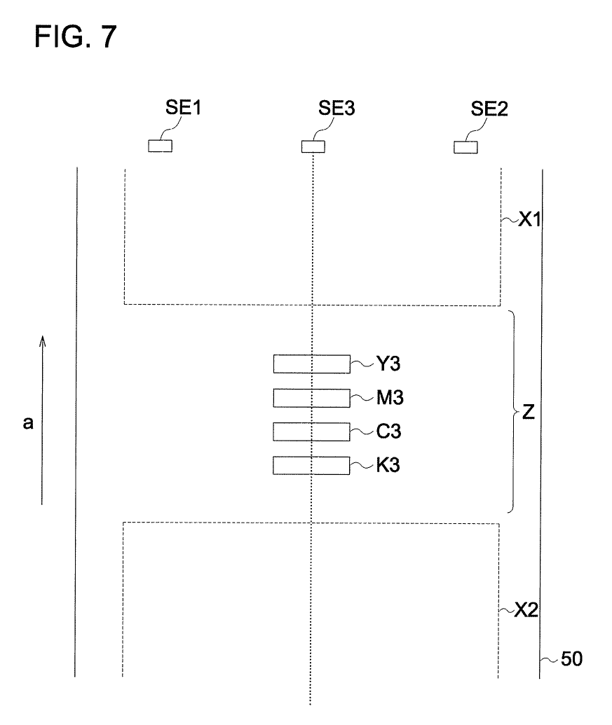

Next, a correction operation of the highest density will be described using FIG. 7. In case where executing the correction operation of the highest density, as illustrated in FIG. 7, the image patterns for the highest density correction of each color (four colors) Y3, M3, C3 and K3 are formed on the intermediate transfer belt 50, and photo sensor SE3 located in the center of the intermediate transfer belt 50 detects the image pattern.

The Image patterns for the highest density correction Y3, M3, C3 and K3 are solid images (solid image for correction), and a solid image means an image obtained when the maximum density is developed in an entire imaging area or a predetermined imaging area of the photoconductor.

The image patterns for the highest density correction Y3, M3, C3 and K3 are formed on the non image area Z between the imaging areas X1 and X2 on the intermediate transfer belt 50, as well as the image pattern for position shifting correction mentioned above. Since it is not necessary to stop a print job which is executed by the image forming apparatus 1 by forming image patterns in the non image area Z, lowering of the productivity can be prevented.

When the image patterns for the highest density correction Y3, M3, C3 and K3 are detected by the photo sensor SE3, based on the detected result, a contrast voltage Vcont, which is a difference between a development bias voltage and a bright section voltage, will be controlled by the CPU101 and will act as desired development conditions. Thereby, the highest density of each color acts as a proper value.

### [Compulsive Ejection of Toner]

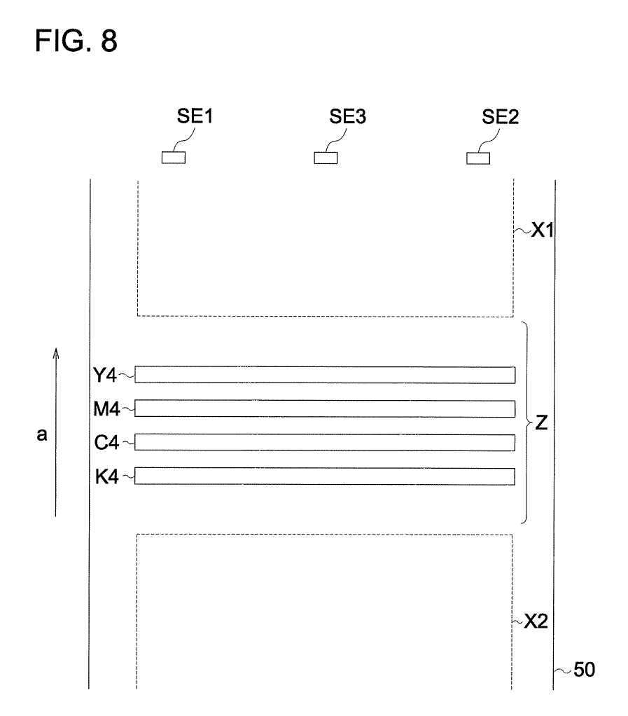

Next, the operation for compulsorily ejecting toner from the developing section 440Y will be described using FIG. 8.

Although the image forming apparatus 1 forms a color image using four image formation engines 40Y, 40M, 40C and 40K, in case where forming a monochrome image, black toner in the image formation engine 40K is consumed. However, other toners are not consumed but stagnating in the developing section 440Y. In this case, the toner which is not consumed deteriorates and quality of the image may be affected. In case where forming a color image of half-tone, a high quality halftone image may be unable to be formed due to the difference in the amount of toners between each of colors consumed by the previous image formation.

Then, as illustrated in FIG. 8, in order to solve these problems, toner images having a belt shape are formed on the intermediate transfer belt 50 so as to make a toner of each color be periodically ejected from the developing section 440Y and the like. The image patterns for compulsive ejection Y4, M4, C4 and K4 are formed in the non image area Z between the imaging areas X1 and X2 on the intermediate transfer belt 50. It is not necessary to stop a print job which is executed by image forming apparatus 1 by forming an image pattern in the non image area Z. Therefore lowering of productivity can be prevented. The Image patterns for compulsive ejection Y4, M4, C4 and K4 are solid images as well as the image patterns for the highest density correction.

Since the image patterns for compulsive ejection Y4, M4, C4 and K4 are formed for the purpose that toner is ejected from the developing section 440Y and the like, the operations for detection by the photo sensors SE1, SE2, and SE3 are not executed. That is, high quality image formation can be performed only by forming image patterns for compulsive ejection Y4, M4, C4 and K4.

### [Execution Timing of Correction Operation]

As described above, in the image forming apparatus 1 in this embodiment, various kinds of correction operations (it is considered that compulsive ejection of toner is also a correction operation), such as the correction operation of position shifting, are executed, and each correction operation is executed with a predetermined timing, for example, the number of prints of the image forming apparatus 1 reaches to a predetermined value.

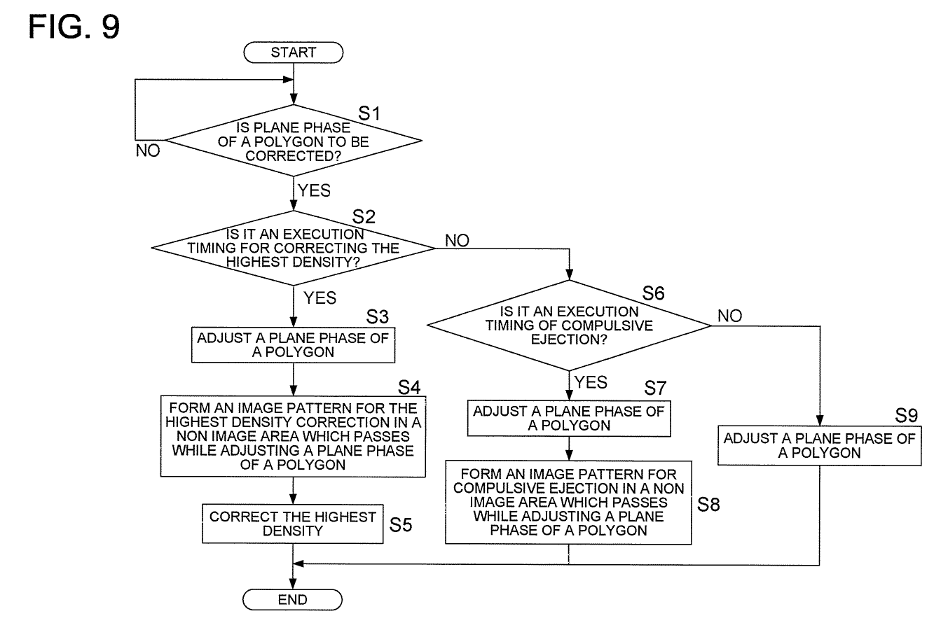

By the way, image patterns for various kinds of corrections are formed in the non image area of the intermediate transfer belt 50, and the correction operation is executed. However, in case where forming image patterns for the position shifting correction and controlling the plane phase of the polygon in the respective exposure sections 430Y, 430M, 430C and 430K, the rotation operation of the polygon is unstable until the plane phase of the polygon turns into a proper phase. Therefore, for the period when the rotation operation of the polygon is unstable, it is not possible to form an image pattern for correction (for example, the image patterns for position shifting correction illustrated in FIG. 4) in which a strict shape is required, onto the photoconductor and the like. However, since the highest density correction image patterns illustrated in FIG. 7 and the image patterns for compulsive ejection illustrated in FIG. 8 are solid images, although the rotation operation of the polygon is unstable, they are not influenced. Then, in case where the execution timing of correction operation of the highest density, or operation which performs compulsive ejection of the toner have come while correcting the plane phase of the polygon, those correction operations are performed using the non image area of the photoconductor or the intermediate transfer belt 50. Hereafter, this point will be described using FIGS. 9-12.

FIG. 9 illustrates a flow chart showing an operation for executing the correction operation of the highest density while correcting the plane phase of the polygon. The operations illustrated in FIG. 9 will be executed based on a predetermined program running on the CPU101, which collaborates with ROM102 and RAM103.

Firstly, it is determined whether the plane phase of the polygon which should be corrected, which is one of the correction operations of position shifting (STEP S1). The timing for correcting the plane phase of the polygon is the timing when a correction operation of position shifting less than one scan line is judged to be necessary in a case where the number of prints of the image forming apparatus 1 reaches to a predetermined value or the case where there is a specific operation for executing the correction operation by a user. Also in case where correcting the magnification of a front surface image and a back surface image formed on the sheet S, the plane phase of the polygon is corrected in consideration of the back surface image position shifting.

In case where it has been determined, according to the result of the correction operation of position shifting, that the plane phase of the polygon should be corrected in STEP S1, it is determined whether it is the execution timing for correcting the highest density (STEP S2). When it has been determined that it is the execution timing for correcting the highest density in STEP S2 (STEP S2; Yes), while correcting the plane phase of the polygon, image patterns for the highest density correction (solid image) are formed in the non image area among the non image areas between imaging areas on a photoconductor, which passes through the exposure position in a period for correcting the plane phase of the polygon (STEP S3). And the image pattern is transferred onto the intermediate transfer belt 50. Then the photo sensor SE3 detects the highest density and the highest density is corrected (STEP S4).

This will be described in detail with reference to FIG. 1.

In case where executing the correction operation of position shifting, image patterns for position shifting correction Y1, Y2, M1, M2, C1, C2, K1 and K2 are formed in the non image area Z1 between imaging areas X1 and x2 on the intermediate transfer belt 50, and these image patterns are detected by photo sensors SE1 and SE2.

The plane phase of the polygon is corrected based on the detection results. However, the non image area on the photoconductor corresponding to the non image area Z2 (the non image area Z2 is located in the downstream side of the non image area Z1 in the moving direction of the intermediate transfer belt 50) of the intermediate transfer belt 50 passes through the exposure position in a period within which the plane phase of the polygon is corrected. Although this period has an unstable rotation operation of the polygon, since the image patterns for the highest density correction are a solid image, and although the rotation operation of the polygon is unstable, there is no influence. Then, the image patterns for the highest density correction are formed in the non image area of the photoconductor which passes through the exposure position in the period within which the plane phase of the polygon is corrected, and the image patterns for the highest density correction Y3, M3, C3, and K3 are to be formed in the non image area Z2 of the intermediate transfer belt 50. As a result, since correction operation of the highest density can be started without waiting until the plane phase of the polygon is stabilized, the correction operation for stabling the image quality can be executed without delay.

The explanation will be continued by returning to FIG. 9. When it is determined that it is not the execution timing for correcting the highest density in STEP S2 (STEP S2; No), next, it will be determined whether it is the execution timing of the compulsive ejection which makes toner be compulsorily ejected from the developing section (STEP S5). When it is determined that it is the execution timing of the compulsive ejection in STEP S5 (STEP S5; Yes), the plane phase of the polygon will be corrected.

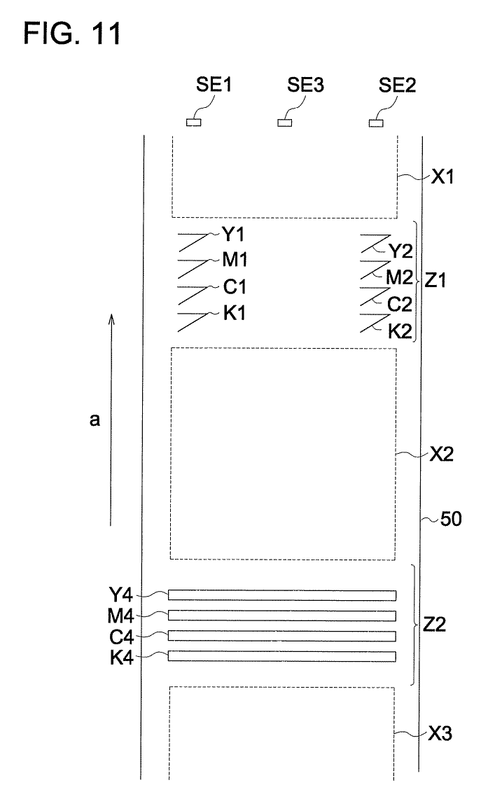

Simultaneously, the image patterns for the compulsive ejection (solid image) are formed onto the non image area between imaging areas on the photoconductor which passes through the exposure position in the period within which the plane phase of the polygon is corrected (STEP S6). This will be explained in detail with reference to FIG. 11.

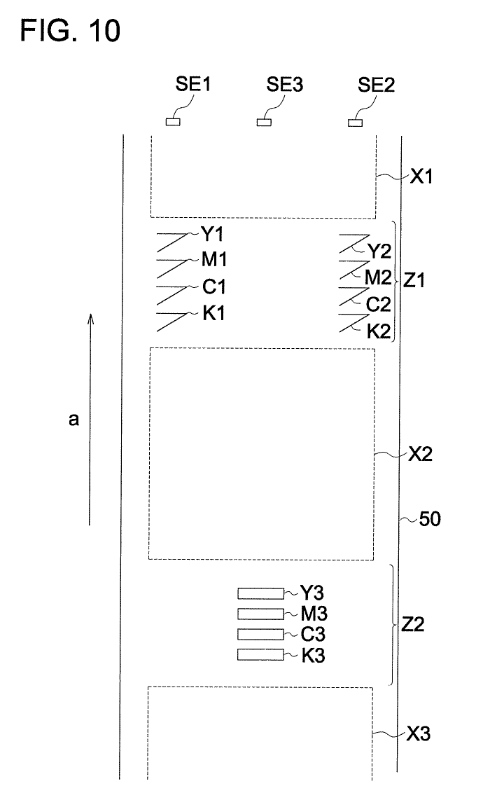

As explained in FIG. 10, in case where executing the correction operation of position shifting, the image patterns for position shifting correction Y1, Y2, M1, M2, C1, C2, K1 and K2 are formed in the non image area Z1 between imaging areas X1 and X2 on the intermediate transfer belt 50. These image patterns are detected by the photo sensors SE1 and SE2. Although the plane phase of the polygon is corrected based on the detection result, the non image area on the photoconductor corresponding to the non image area Z2 of the intermediate transfer belt 50 passes through the exposure position in the period within which the plane phase of the polygon is corrected. Although within this period, the operation of the polygon is unstable, since the image patterns for compulsive ejection are solid images, and although the rotation operation of the polygon is unstable, there is no influence. Then, the image patterns for compulsive ejection are formed in the non image area of the photoconductor which passes through the exposure position in the period within which the plane phase of the polygon is corrected, and the image patterns for compulsive ejection Y4, M4, C4 and K4 are formed in the non image area Z2 of the intermediate transfer belt 50. As a result, since the compulsive ejection of the toner is possible without waiting until the plane phase of the polygon is stabilized, the correction operation for stabilizing the image quality can be executed without delay.

In STEP S5 of FIG. 9, when it is determined that it is not the execution timing of compulsive ejection (STEP S5; No), the plane phase of the polygon will be adjusted (STEP S7), and the correction operation of position shifting will be completed.

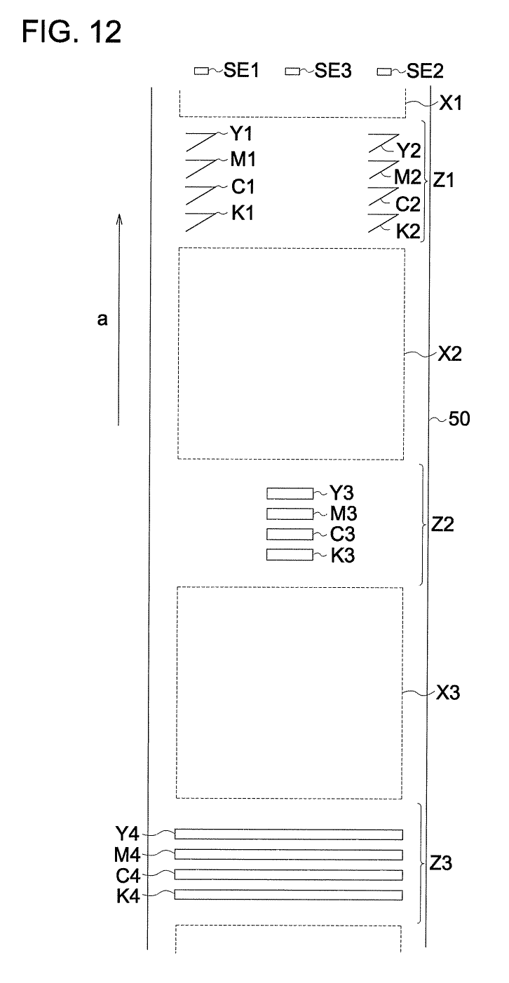

In case where the execution timing of correction operation of position shifting overlaps with the correction operation of the highest density and the operation of compulsive ejection of toner, and the correction operation of the plane phase of the polygon is executed over a plurality of non image areas, as illustrated in FIG. 12, image patterns for the highest density correction Y3, M3, C3, K3 and image patterns for compulsive ejection Y4, M4, C4, and K4 may be continuously formed in a plurality of non image areas Z2 and Z3 to quickly execute the correction operation.

As explained using FIGS. 9-12 above, the image patterns for the highest density correction and image patterns for compulsive ejection which are solid images are formed in the non image area of the photoconductor which passes through the exposure position in a period for correcting the plane phase of the polygon. The correction operation which stabilizes image quality can be executed without delay by performing the correction operation, without waiting until the rotation operation of the polygon is stabilized. Lowering the productivity can be prevented without stopping a print job, in case when an image pattern for correction is formed in the non image area and the correction operation is executed. It is effective when the operation illustrated in FIG. 9 is particularly executed in the image forming apparatus 1 of a tandem form in which high-speed image formation is possible.

The present invention is not limited to the above embodiment and various changes and modification my be made without departing from the scope of the invention. In this embodiment, although the correction operation of position shifting and the correction operation of the highest density have been described, the present invention is not limited to these correction operations.

What is claimed is:

1. An image forming apparatus comprising:
an image carrier;
an exposure section that deflects an optical beam using a rotating polygon mirror to expose a surface of the image carrier;
a developing section that supplies a toner in order to visualize an electrostatic latent image formed by the exposure section on the image carrier with a toner; and
a control section that controls at least the exposure section and the developing section, wherein the control section controls the exposure section and the developing section so as to form a solid image for correction on a non image area which passes through an exposure position in a period within which a plane phase of the rotating polygon mirror is corrected among non image areas between imaging areas on the image carrier.

2. The image forming apparatus of claim 1, wherein the control section corrects the plane phase of the rotating polygon mirror so as to correct a exposure position by the exposure section.

3. The image forming apparatus of claim 1, wherein the control section controls the exposure section and the developing section so as to form an image pattern for position shifting correction on one of the non image areas between the imaging areas on the image carrier, and the control section controls a photo sensor to detect the image pattern and corrects the plane phase of the rotating polygon mirror based on a result of the detection by the photo sensor.

4. The image forming apparatus of claim 1, wherein the solid image for correction is a solid image to be formed on the image carrier to correct the highest density of an image to be formed on the image carrier.

5. The image forming apparatus of claim 1, wherein the solid image for correction is a solid image to be formed on the image carrier in order to compulsorily eject toner from the developing section.

6. The image forming apparatus of claim 1, wherein the control section is configured to execute a correction operation of a position shifting correction when a number of prints of the image forming apparatus reaches to a predetermined value.

7. The image forming apparatus of claim 1, wherein the control section corrects the plane phase of the rotating polygon mirror when correcting a magnification of a front surface image and a back surface image.

8. The image forming apparatus of claim 1, comprising a plurality of the image carriers.

9. The image forming apparatus of claim 1, comprising a plurality of the exposure sections.

10. The image forming apparatus of claim 8, further comprising an intermediate transfer member on which a toner image of each color is formed.

11. The image forming apparatus of claim 8, further comprising a plurality of the exposure sections.

12. The image forming apparatus of claim 11, further comprising a plurality of the developing sections.

13. The image forming apparatus of claim 12, wherein each of the plurality of developing sections is configured to supply a toner of each color.
